(19) United States
(12) Patent Application Publication
(10) Pub. No.: US 2026/0239269 A1
(43) Pub. Date: Aug. 13, 2026

(54) SELECTING SIDELINK POSITIONING DEVICES IN A WIRELESS COMMUNICATION NETWORK

(71) Applicant: Lenovo (Singapore) Pte. Limited, Singapore (SG)

(72) Inventors: Hyung-Nam Choi, Ottobrunn (DE); Robin Rajan Thomas, Bad Nauheim (DE); Dimitrios Karampatsis, Ruislip (GB)

(73) Assignee: Lenovo (Singapore) Pte. Limited, Singapore (SG)

(21) Appl. No.: 19/151,562

(22) PCT Filed: May 16, 2023
(86) PCT No.: PCT/EP2023/063130

§ 371 Date: Jul. 28, 2025

(30) Foreign Application Priority Data
Mar. 29, 2023 (GR) 20230100263

(51) Int. Cl. H04W 64/00; H04W 72/25

(52) U.S. Cl. CPC H04W 64/00; H04W 72/25

(57) ABSTRACT

There is provided, a user equipment ‘UE’ apparatus for wireless communication, comprising: a processor, and a memory coupled with the processor, the processor configured to cause the UE apparatus to: transmit, to a first apparatus of a wireless communication network, a first message, wherein the first message comprises one or more parameters indicating sidelink positioning capabilities of the UE apparatus.

### FIELD

The subject matter disclosed herein relates generally to the field of implementing the selecting of sidelink positioning devices in a wireless communication network. This document defines a user equipment apparatus for wireless communication, a first apparatus and second apparatus in a wireless communication network, and methods in a user equipment apparatus, first apparatus and second apparatus.

### INTRODUCTION

Sidelink (SL) positioning in Rel-18 New Radio (NR) has been considered by the Third-Generation Partnership Project (3GPP) in the 3GPP Work Item Description (WID) RP-223549, titled “New WID on Expanded and Improved NR Positioning”. This has been considered in order to support certain target accuracy requirements for SL positioning.

SL positioning is intended to be applied for a variety of use-cases such as Vehicle-to-Everything (V2X), public safety, Industrial Internet of Things (IIoT) and commercial use cases. The aim of SL positioning is to determine the position of a User Equipment (UE) by using SL positioning methods such as Round Trip Time (RTT)-type solutions using SL, SL-Angle of Arrival (AoA) and SL-Time Difference of Arrival (TDOA).

SL positioning will be based on a new SL Positioning Reference Signal (PRS) that is transmitted over the PC5 interface and will be supported in all coverage scenarios (i.e. in-coverage, partial coverage and out-of-coverage scenarios) and for PC5-only-based and joint PC5-Uu-based operation scenarios. For exchanging the SL positioning related information between UEs over the PC5 interface a new protocol denoted as Sidelink Positioning Protocol (SLPP) will be introduced. The functionalities that shall be supported by SLPP include SL Positioning Capability Transfer; SL Positioning Assistance Data exchange; SL Location Information Transfer; Error handling; and Abort.

The cast types which are considered for SLPP signaling include unicast, groupcast and broadcast, but unicast/one-to-one operation is assumed as baseline for the exchange of SLPP signaling between UEs. For exchange of SL positioning capability and SL positioning assistance data information, groupcast and broadcast (in addition to unicast) are assumed to be supported only when the protection of groupcast/broadcast of SL positioning signaling can be ensured.

### SUMMARY

In Uu-based positioning, an Access and Mobility Management Function (AMF) performs Location Management Function (LMF) selection based on available information (e.g. requested Location Services (LCS) Quality of Service (QoS) requirements, LMF capabilities, LMF load, LMF location) or based on AMF local configuration (if the AMF is configured locally with a mapping table of UE identity and LMF address).

Now, in joint PC5-Uu-based positioning, the AMF may need to select an LMF with SL positioning capabilities for result calculation, method determination, assistance data distribution and Anchor UE selection. Based on the requested LCS QoS, the AMF knows whether SL positioning is required for the Mobile-Terminated Location Request (MT-LR) or Mobile-Originated Location Request (MO-LR) procedures. However, there are certain issues for the AMF when selecting an LMF. In particular, an SL positioning capable LMF may be available but due to current load the LMF may decide that an SL Positioning Server UE is required to execute the result calculation, method determination, assistance data distribution and/or Anchor UE selection. Furthermore, an LMF that is available may not be SL positioning capable.

In order to solve the above issues, a solution is needed on how the AMF can provide the selected LMF with information about available SL Positioning Server UEs and Anchor UEs so that the LMF can be enabled to perform SL positioning.

Whilst a straightforward solution to support SL positioning in joint PC5-Uu-based positioning operation scenario is to configure the AMF locally with a mapping table of UE identity and LMF address of SL positioning capable LMFs, this solution is quite static and furthermore cannot avoid the beforementioned issues, entirely.

Disclosed herein are procedures for selecting sidelink positioning devices in a wireless communication network. Said procedures may be implemented by a user equipment apparatus for wireless communication, a first apparatus and second apparatus in a wireless communication network, and methods in a user equipment apparatus, first apparatus and second apparatus.

There is provided, a user equipment ‘UE’ apparatus for wireless communication, comprising: a processor; and a memory coupled with the processor, the processor configured to cause the UE apparatus to: transmit, to a first apparatus of a wireless communication network, a first message, wherein the first message comprises one or more parameters indicating sidelink positioning capabilities of the UE apparatus.

There is further provided, a first apparatus in a wireless communication network, comprising: a processor; and a memory coupled with the processor, the processor configured to cause the first apparatus to: receive, from a consumer entity, a request for locating a target UE in a target area; determine, one or more UE apparatuses having respective sidelink positioning capabilities in the target area; and transmit, to a second apparatus of the wireless communication network, a fourth message indicating the one or more UE apparatuses and their respective sidelink positioning capabilities.

There is further provided, a second apparatus in a wireless communication network, comprising: a processor; and a memory coupled with the processor, the processor configured to cause the second apparatus to: receive, from a first apparatus of the wireless communication network, a fourth message indicating one or more UE apparatuses and their respective sidelink positioning capabilities for locating a target UE in a target area; determine a server-UE apparatus, from the one or more UE apparatuses, for performing location calculation for sidelink positioning of the target UE; and transmit, to the server-UE apparatus, a second message requesting sidelink positioning of the target UE, wherein the second message comprises: one or more QoS requirements for location estimation of the target UE; and one or more identifiers of one or more anchor-UEs in the target area of the target UE.

There is further provided, a method in a user equipment apparatus for wireless communication, comprising: transmitting, to a first apparatus of a wireless communication network, a first message, wherein the first message comprises one or more parameters indicating sidelink positioning capabilities of the UE apparatus.

There is further provided, a method in a first apparatus in a wireless communication network, comprising: receiving, from a consumer entity, a request for locating a target UE in a target area; determining, one or more UE apparatuses having respective sidelink positioning capabilities in the target area; and transmitting, to a second apparatus of the wireless communication network, a fourth message indicating the one or more UE apparatuses and their respective sidelink positioning capabilities.

There is further provided, a method in a second apparatus in a wireless communication network, comprising: receiving, from a first apparatus of the wireless communication network, a fourth message indicating one or more UE apparatuses and their respective sidelink positioning capabilities for locating a target UE in a target area; determining a server-UE apparatus, from the one or more UE apparatuses, for performing location calculation for sidelink positioning of the target UE; and transmitting, to the server-UE apparatus, a second message requesting sidelink positioning of the target UE, wherein the second message comprises: one or more QoS requirements for location estimation of the target UE; and one or more identifiers of one or more anchor-UEs in the target area of the target UE.

### BRIEF DESCRIPTION OF THE DRAWINGS

In order to describe the manner in which advantages and features of the disclosure can be obtained, a description of the disclosure is rendered by reference to certain apparatus and methods which are illustrated in the appended drawings. Each of these drawings depict only certain aspects of the disclosure and are not therefore to be considered to be limiting of its scope. The drawings may have been simplified for clarity and are not necessarily drawn to scale.

Methods and apparatus for selecting sidelink positioning devices in a wireless communication network will now be described, by way of example only, with reference to the accompanying drawings, in which:

FIG. 1 illustrates an embodiment of a wireless communication system;

FIG. 2 illustrates an embodiment of a user equipment apparatus;

FIG. 3 illustrates an embodiment of a network node;

FIG. 4 illustrates an example of LPP message transfer between an LMF and a UE;

FIG. 5 illustrates an example of an LCS architecture;

FIG. 6 illustrates an example of the 5GC-MT-LR procedure for the regulatory location service for non-roaming;

FIG. 7 illustrates an example of the 5GC-MO-LR procedure;

FIG. 8 illustrates examples of sidelink communication scenarios;

FIG. 9 illustrates an embodiment of a format for signaling SL positioning capability;

FIG. 10 illustrates an embodiment of a format for listing SL positioning information in an Nlmf_Location_DetermineLocation Request message;

FIG. 11 illustrates the message flow in an embodiment of a joint PC5-Uu-based positioning operation scenario;

FIG. 12 illustrates an embodiment of a method in a user equipment apparatus;

FIG. 13 illustrates an embodiment of a method in a first apparatus; and

FIG. 14 illustrates an embodiment of a method in a second apparatus.

### DETAILED DESCRIPTION

As will be appreciated by one skilled in the art, aspects of this disclosure may be embodied as a system, apparatus, method, or program product. Accordingly, arrangements described herein may be implemented in an entirely hardware form, an entirely software form (including firmware, resident software, micro-code, etc.) or a form combining software and hardware aspects.

For example, the disclosed methods and apparatus may be implemented as a hardware circuit comprising custom very-large-scale integration (“VLSI”) circuits or gate arrays, off-the-shelf semiconductors such as logic chips, transistors, or other discrete components. The disclosed methods and apparatus may also be implemented in programmable hardware devices such as field programmable gate arrays, programmable array logic, programmable logic devices, or the like. As another example, the disclosed methods and apparatus may include one or more physical or logical blocks of executable code which may, for instance, be organized as an object, procedure, or function.

Furthermore, the methods and apparatus may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In certain arrangements, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store, a program for use by or in connection with an instruction execution system, apparatus, or device.

Reference throughout this specification to an example of a particular method or apparatus, or similar language, means that a particular feature, structure, or characteristic described in connection with that example is included in at least one implementation of the method and apparatus described herein. Thus, reference to features of an example of a particular method or apparatus, or similar language, may, but do not necessarily, all refer to the same example, but mean “one or more but not all examples” unless expressly specified otherwise. The terms “including”, “comprising”, “having”, and variations thereof, mean “including but not limited to”, unless expressly specified otherwise. An enumerated listing of items does not imply that any or all of the items are mutually exclusive, unless expressly specified otherwise. The terms “a”, “an”, and “the” also refer to “one or more”, unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one, and only one, of any single item in the list. For example, “one of A, B and C” includes only A, only B or only C and excludes combinations of A, B and C. As used herein, “a member selected from the group consisting of A, B, and C” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Furthermore, the described features, structures, or characteristics described herein may be combined in any suitable manner. In the following description, numerous specific details are provided, such as examples of programming, software modules, user selections, network transactions, database queries, database structures, hardware modules, hardware circuits, hardware chips, etc., to provide a thorough understanding of the disclosure. One skilled in the relevant art will recognize, however, that the disclosed methods and apparatus may be practiced without one or more of the specific details, or with other methods, components, materials, and so forth. In other instances, well-known structures, materials, or operations are not shown or described in detail to avoid obscuring aspects of the disclosure.

Aspects of the disclosed method and apparatus are described below with reference to schematic flowchart diagrams and/or schematic block diagrams of methods, apparatuses, systems, and program products. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams.

The code may also be loaded onto a computer, other programmable data processing apparatus, or other devices to cause a series of operational steps to be performed on the computer, other programmable apparatus, or other devices to produce a computer implemented process such that the code which executes on the computer or other programmable apparatus provides processes for implementing the functions/acts specified in the schematic flowchart diagrams and/or schematic block diagram.

The schematic flowchart diagrams and/or schematic block diagrams in the Figures illustrate the architecture, functionality, and operation of possible implementations of apparatuses, systems, methods, and program products. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

The description of elements in each figure may refer to elements of proceeding Figures. Like numbers refer to like elements in all Figures.

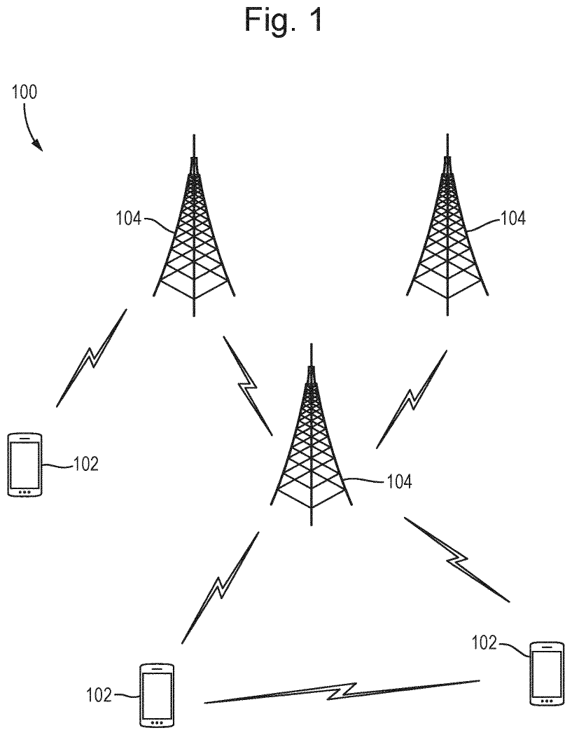

FIG. 1 depicts an embodiment of a wireless communication system 100 for selecting sidelink positioning devices in a wireless communication network. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100. The wireless communication system may comprise a wireless communication network and at least one wireless communication device. The wireless communication device is typically a 3GPP User Equipment (UE). The wireless communication network may comprise at least one network node. The network node may be a network unit.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to as an access point, an access terminal, a base, a base station, a Node-B, an eNB, a gNB, a Home Node-B, a relay node, a device, a core network, an aerial server, a radio access node, an AP, NR, a network entity, an Access and Mobility Management Function (“AMF”), a Unified Data Management Function (“UDM”), a Unified Data Repository (“UDR”), a UDM/UDR, a Policy Control Function (“PCF”), a Radio Access Network (“RAN”), an Network Slice Selection Function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), an application function, a service enabler architecture layer (“SEAL”) function, a vertical application enabler server, an edge enabler server, an edge configuration server, a mobile edge computing platform function, a mobile edge computing application, an application data analytics enabler server, a SEAL data delivery server, a middleware entity, a network slice capability management server, or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with New Radio (NR) protocols standardized in 3GPP, wherein the network unit 104 transmits using an Orthogonal Frequency Division Multiplexing (“OFDM”) modulation scheme on the downlink (DL) and the remote units 102 transmit on the uplink (UL) using a Single Carrier Frequency Division Multiple Access (“SC-FDMA”) scheme or an OFDM scheme. More generally, however, the wireless communication system 100 may implement some other open or proprietary communication protocol, for example, WiMAX, IEEE 802.11 variants, GSM, GPRS, UMTS, LTE variants, CDMA2000, Bluetooth®, ZigBee, Sigfox, LoraWAN among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

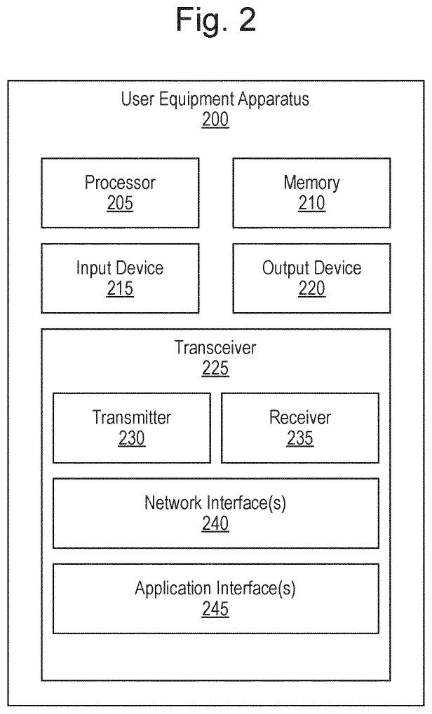

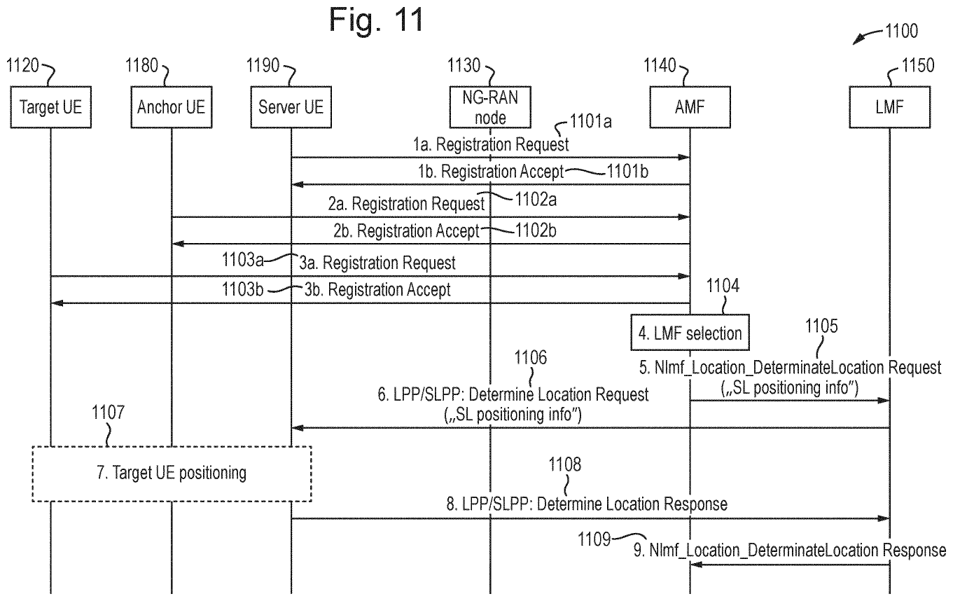

FIG. 2 depicts a user equipment apparatus 200 that may be used for implementing the methods described herein. The user equipment apparatus 200 is used to implement one or more of the solutions described herein. The user equipment apparatus 200 is in accordance with one or more of the user equipment apparatuses described in embodiments herein. In particular, the user equipment apparatus 200 may comprise a UE 530 of FIG. 5 or a UE 1120, 1180, 1190 of FIG. 11, for instance. The user equipment apparatus 200 includes a processor 205, a memory 210, an input device 215, an output device 220, and a transceiver 225.

The input device 215 and the output device 220 may be combined into a single device, such as a touchscreen. In some implementations, the user equipment apparatus 200 does not include any input device 215 and/or output device 220. The user equipment apparatus 200 may include one or more of: the processor 205, the memory 210, and the transceiver 225, and may not include the input device 215 and/or the output device 220.

As depicted, the transceiver 225 includes at least one transmitter 230 and at least one receiver 235. The transceiver 225 may communicate with one or more cells (or wireless coverage areas) supported by one or more base units. The transceiver 225 may be operable on unlicensed spectrum. Moreover, the transceiver 225 may include multiple UE panels supporting one or more beams. Additionally, the transceiver 225 may support at least one network interface 240 and/or application interface 245. The application interface(s) 245 may support one or more APIs. The network interface(s) 240 may support 3GPP reference points, such as Uu, N1, PC5, etc. Other network interfaces 240 may be supported, as understood by one of ordinary skill in the art.

The processor 205 may include any known controller capable of executing computer-readable instructions and/or capable of performing logical operations. For example, the processor 205 may be a microcontroller, a microprocessor, a central processing unit (“CPU”), a graphics processing unit (“GPU”), an auxiliary processing unit, a field programmable gate array (“FPGA”), or similar programmable controller. The processor 205 may execute instructions stored in the memory 210 to perform the methods and routines described herein. The processor 205 is communicatively coupled to the memory 210, the input device 215, the output device 220, and the transceiver 225.

The processor 205 may control the user equipment apparatus 200 to implement the user equipment apparatus behaviors described herein. The processor 205 may include an application processor (also known as “main processor”) which manages application-domain and operating system (“OS”) functions and a baseband processor (also known as “baseband radio processor”) which manages radio functions.

The memory 210 may be a computer readable storage medium. The memory 210 may include volatile computer storage media. For example, the memory 210 may include a RAM, including dynamic RAM (“DRAM”), synchronous dynamic RAM (“SDRAM”), and/or static RAM (“SRAM”). The memory 210 may include non-volatile computer storage media. For example, the memory 210 may include a hard disk drive, a flash memory, or any other suitable non-volatile computer storage device. The memory 210 may include both volatile and non-volatile computer storage media.

The memory 210 may store data related to implement a traffic category field as described herein. The memory 210 may also store program code and related data, such as an operating system or other controller algorithms operating on the apparatus 200.

The input device 215 may include any known computer input device including a touch panel, a button, a keyboard, a stylus, a microphone, or the like. The input device 215 may be integrated with the output device 220, for example, as a touchscreen or similar touch-sensitive display. The input device 215 may include a touchscreen such that text may be input using a virtual keyboard displayed on the touchscreen and/or by handwriting on the touchscreen. The input device 215 may include two or more different devices, such as a keyboard and a touch panel.

The output device 220 may be designed to output visual, audible, and/or haptic signals. The output device 220 may include an electronically controllable display or display device capable of outputting visual data to a user. For example, the output device 220 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 220 may include a wearable display separate from, but communicatively coupled to, the rest of the user equipment apparatus 200, such as a smart watch, smart glasses, a heads-up display, or the like. Further, the output device 220 may be a component of a smart phone, a personal digital assistant, a television, a table computer, a notebook (laptop) computer, a personal computer, a vehicle dashboard, or the like.

The output device 220 may include one or more speakers for producing sound. For example, the output device 220 may produce an audible alert or notification (e.g., a beep or chime). The output device 220 may include one or more haptic devices for producing vibrations, motion, or other haptic feedback. All, or portions, of the output device 220 may be integrated with the input device 215. For example, the input device 215 and output device 220 may form a touchscreen or similar touch-sensitive display. The output device 220 may be located near the input device 215.

The transceiver 225 communicates with one or more network functions of a mobile communication network via one or more access networks. The transceiver 225 operates under the control of the processor 205 to transmit messages, data, and other signals and also to receive messages, data, and other signals. For example, the processor 205 may selectively activate the transceiver 225 (or portions thereof) at particular times in order to send and receive messages.

The transceiver 225 includes at least one transmitter 230 and at least one receiver 235. The one or more transmitters 230 may be used to provide uplink communication signals to a base unit of a wireless communication network. Similarly, the one or more receivers 235 may be used to receive downlink communication signals from the base unit. Although only one transmitter 230 and one receiver 235 are illustrated, the user equipment apparatus 200 may have any suitable number of transmitters 230 and receivers 235. Further, the transmitter(s) 230 and the receiver(s) 235 may be any suitable type of transmitters and receivers. The transceiver 225 may include a first transmitter/receiver pair used to communicate with a mobile communication network over licensed radio spectrum and a second transmitter/receiver pair used to communicate with a mobile communication network over unlicensed radio spectrum.

The first transmitter/receiver pair may be used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. The first transmitter/receiver pair and the second transmitter/receiver pair may share one or more hardware components. For example, certain transceivers 225, transmitters 230, and receivers 235 may be implemented as physically separate components that access a shared hardware resource and/or software resource, such as for example, the network interface 240.

One or more transmitters 230 and/or one or more receivers 235 may be implemented and/or integrated into a single hardware component, such as a multi-transceiver chip, a system-on-a-chip, an Application-Specific Integrated Circuit (“ASIC”), or other type of hardware component. One or more transmitters 230 and/or one or more receivers 235 may be implemented and/or integrated into a multi-chip module. Other components such as the network interface 240 or other hardware components/circuits may be integrated with any number of transmitters 230 and/or receivers 235 into a single chip. The transmitters 230 and receivers 235 may be logically configured as a transceiver 225 that uses one more common control signals or as modular transmitters 230 and receivers 235 implemented in the same hardware chip or in a multi-chip module.

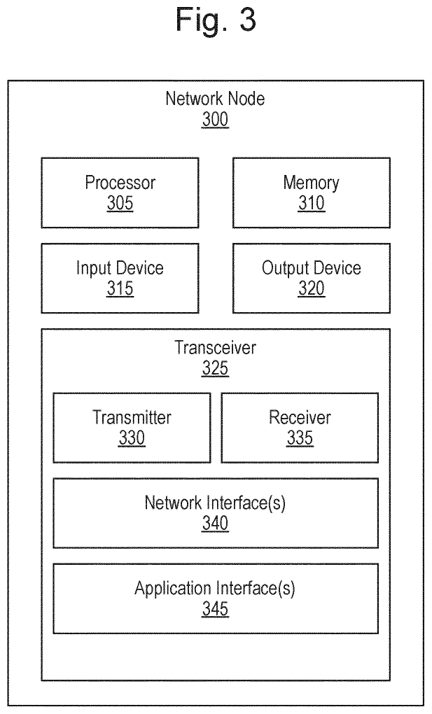

FIG. 3 depicts further details of the network node 300 that may be used for implementing the methods described herein. The network node 300 may be one implementation of an entity in the wireless communication network, e.g. in one or more of the wireless communication networks described herein. The network node 300 may comprise an AMF 522 or an LMF 523 of FIG. 5, or an AMF 1140 or LMF 1150 of FIG. 11, for instance. The network node 300 includes a processor 305, a memory 310, an input device 315, an output device 320, and a transceiver 325.

The input device 315 and the output device 320 may be combined into a single device, such as a touchscreen. In some implementations, the network node 300 does not include any input device 315 and/or output device 320. The network node 300 may include one or more of: the processor 305, the memory 310, and the transceiver 325, and may not include the input device 315 and/or the output device 320.

As depicted, the transceiver 325 includes at least one transmitter 330 and at least one receiver 335. Here, the transceiver 325 communicates with one or more remote units 200. Additionally, the transceiver 325 may support at least one network interface 340 and/or application interface 345. The application interface(s) 345 may support one or more APIs. The network interface(s) 340 may support 3GPP reference points, such as Uu, N1, N2 and N3. Other network interfaces 340 may be supported, as understood by one of ordinary skill in the art.

The processor 305 may include any known controller capable of executing computer-readable instructions and/or capable of performing logical operations. For example, the processor 305 may be a microcontroller, a microprocessor, a CPU, a GPU, an auxiliary processing unit, a FPGA, or similar programmable controller. The processor 305 may execute instructions stored in the memory 310 to perform the methods and routines described herein. The processor 305 is communicatively coupled to the memory 310, the input device 315, the output device 320, and the transceiver 325.

The memory 310 may be a computer readable storage medium. The memory 310 may include volatile computer storage media. For example, the memory 310 may include a RAM, including dynamic RAM (“DRAM”), synchronous dynamic RAM (“SDRAM”), and/or static RAM (“SRAM”). The memory 310 may include non-volatile computer storage media. For example, the memory 310 may include a hard disk drive, a flash memory, or any other suitable non-volatile computer storage device. The memory 310 may include both volatile and non-volatile computer storage media.

The memory 310 may store data related to establishing a multipath unicast link and/or mobile operation. For example, the memory 310 may store parameters, configurations, resource assignments, policies, and the like, as described herein. The memory 310 may also store program code and related data, such as an operating system or other controller algorithms operating on the network node 300.

The input device 315 may include any known computer input device including a touch panel, a button, a keyboard, a stylus, a microphone, or the like. The input device 315 may be integrated with the output device 320, for example, as a touchscreen or similar touch-sensitive display. The input device 315 may include a touchscreen such that text may be input using a virtual keyboard displayed on the touchscreen and/or by handwriting on the touchscreen. The input device 315 may include two or more different devices, such as a keyboard and a touch panel.

The output device 320 may be designed to output visual, audible, and/or haptic signals. The output device 320 may include an electronically controllable display or display device capable of outputting visual data to a user. For example, the output device 320 may include, but is not limited to, an LCD display, an LED display, an OLED display, a projector, or similar display device capable of outputting images, text, or the like to a user. As another, non-limiting, example, the output device 320 may include a wearable display separate from, but communicatively coupled to, the rest of the network node 300, such as a smart watch, smart glasses, a heads-up display, or the like. Further, the output device 320 may be a component of a smart phone, a personal digital assistant, a television, a table computer, a notebook (laptop) computer, a personal computer, a vehicle dashboard, or the like.

The output device 320 may include one or more speakers for producing sound. For example, the output device 320 may produce an audible alert or notification (e.g., a beep or chime). The output device 320 may include one or more haptic devices for producing vibrations, motion, or other haptic feedback. All, or portions, of the output device 320 may be integrated with the input device 315. For example, the input device 315 and output device 320 may form a touchscreen or similar touch-sensitive display. The output device 320 may be located near the input device 315.

The transceiver 325 includes at least one transmitter 330 and at least one receiver 335. The one or more transmitters 330 may be used to communicate with the UE, as described herein. Similarly, the one or more receivers 335 may be used to communicate with network functions in the PLMN and/or RAN, as described herein. Although only one transmitter 330 and one receiver 335 are illustrated, the network node 300 may have any suitable number of transmitters 330 and receivers 335. Further, the transmitter(s) 330 and the receiver(s) 335 may be any suitable type of transmitters and receivers.

To assist the understanding of the solutions disclosed herein, descriptions of certain target accuracy requirements, certain features, and certain functionalities, will now be provided.

The target accuracy requirements for SL positioning in specific 3GPP use-cases, are provided in Table 1. The references to “Set A” and “Set B” indicate the categorization of requirements into two sets.

TABLE 1

| SL | | | | |
|---|---|---|---|---|
| Positioning | | Public | | |
| KPIs | V2X | Safety | IIoT | Commercial |
| Horizontal | Set A: 1.5 m | 1 m for | Set A: 1 m | 1 m for |
| Positioning | for 90% of | 90% of UEs | for 90% of | 90% of UEs |
| Accuracy | UEs | (absolute | UEs | (absolute |
| | (absolute or | or relative) | (absolute or | or relative) |
| | relative) | | relative) | |
| | Set B: 0.5 m | | Set B: 0.2 m | |
| | for 90% of | | for 90% of | |
| | UEs | | UEs | |
| | (absolute or | | (absolute or | |
| | relative) | | relative) | |
| Vertical | Set A: 3 m | 2 m (absolute | Set A: 1 m | 2 m for |
| Positioning | for 90% of | or relative | for 90% of | 90% of UEs |
| Accuracy | UEs | between | UEs | (absolute |
| | (absolute or | 2 UEs) for | (absolute or | or relative) |
| | relative) | 90% of UEs | relative) | |
| | Set B: 2 m | 0.3 m (relative | Set B: 0.2 m | |
| | for 90% | positioning | for 90% of | |
| | of UEs | change for 1 | UEs | |
| | (absolute or | UE) for 90% | (absolute or | |
| | relative) | of UEs | relative) | |
| Relative | — | Up to 30 km/h | Up to 30 | Up to |
| Speed | | | km/h | 30 km/h |

| | |
|---|---|
| Angle | Set A: Y = ±15° for 90% of the UEs |
| Accuracy | Set B: Y = ±8° for 90% of the UEs |

The support of positioning in NR shall also be described. In 3GPP Rel-15 only Cell-ID and Radio Access Technology (RAT)-independent positioning methods (e.g. global navigation satellite systems (GNSS)) are supported in NR. In order to meet the positioning requirements for regulatory (i.e. emergency services) and commercial use cases (e.g. IIoT) as listed in Table 2, RAT-dependent (for both Frequency Range (FR)1 and FR2) and RAT-independent positioning methods (such as Precise Point Positioning (PPP) and Real Time Kinematic (RTK)) have been specified in 3GPP Rel-16. Table 3 further shows the list of RAT-dependent positioning methods which were specified in 3GPP Rel-16.

TABLE 2

| Positioning | Regulatory | |
|---|---|---|
| requirement | use cases | Commercial use cases |
| Horizontal positioning | <=50 m for | <3 m for 80% of UEs in indoor |
| error (accuracy) | 80% of UEs | deployment scenarios |
| | | <10 m for 80% of UEs in |
| | | outdoor deployments scenarios |
| Vertical positioning error | <5 m for | <3 m for 80% of UEs in indoor |
| (accuracy) | 80% of UEs | deployment scenarios |
| | | <3 m for 80% of UEs in |
| | | outdoor deployment scenarios |
| End to end latency and | <30 seconds | |
| TTFF | | |
| End to end latency | | <1 s |

TABLE 3

| | | UE-assisted, | NG-RAN node |
|---|---|---|---|
| Method | UE-based | LMF-based | assisted |
| DL-TDOA | Yes | Yes | No |
| DL-AoD | Yes | Yes | No |
| Multi-RTT | No | Yes | Yes |
| NR E-CID | No | Yes | Yes |
| UL-TDOA | No | No | Yes |
| UL-AoA | No | No | Yes |

Furthermore, the higher positioning requirements for commercial use cases and specifically IIoT use cases are listed in Table 4.

TABLE 4

| Positioning | Commercial | IIoT |
|---|---|---|
| requirement | use cases | use cases |
| Horizontal position | (<1 m) for | (<0.2 m) for |
| accuracy | 90% of UEs | 90% of UEs |
| Vertical position | (<3 m) for | (<1 m) for |
| accuracy | 90% of UEs | 90% of UEs |
| End to end latency | (<100 ms) | (<100 ms, in |
| for position | | the order of 10 |
| estimation | | ms is desired) |
| PHY latency for | (<10 ms) | (<10 ms) |
| position estimation | | |

In order to meet, in particular, the higher positioning requirements as specified in Table 4, further enhancements for NR positioning have been specified in 3GPP Rel-17. These include: improvements of positioning accuracy and latency (uplink-angle of arrival (UL-AoA) enhancements, downlink-angle of departure (DL-AoD) enhancements, Preconfigured measurement gap, Preconfigured positioning reference signal (PRS) processing window etc.); improvements of network efficiency (On-Demand PRS transmission); improvement of device efficiency (Positioning in RRC_INACTIVE); providing high integrity and reliability requirements (GNSS integrity); and enhancements of Assisted-GNSS positioning.

In the 5GS architecture that is applicable to positioning of a UE, either the UE itself or the location server determines the UE position depending on the applied positioning method. And for exchanging the positioning related information (e.g. location related measurements, location estimates, assistance data), LPP as specified in 3GPP Technical Specification TS 37.355, titled “LTE Positioning Protocol(LPP)”, is used point-to-point between the location server and the UE. In LPP the following message types are supported: Request Capabilities; Provide Capabilities; Request Assistance Data; Provide Assistance Data; Request Location Information; Provide Location Information; Abort; and Error.

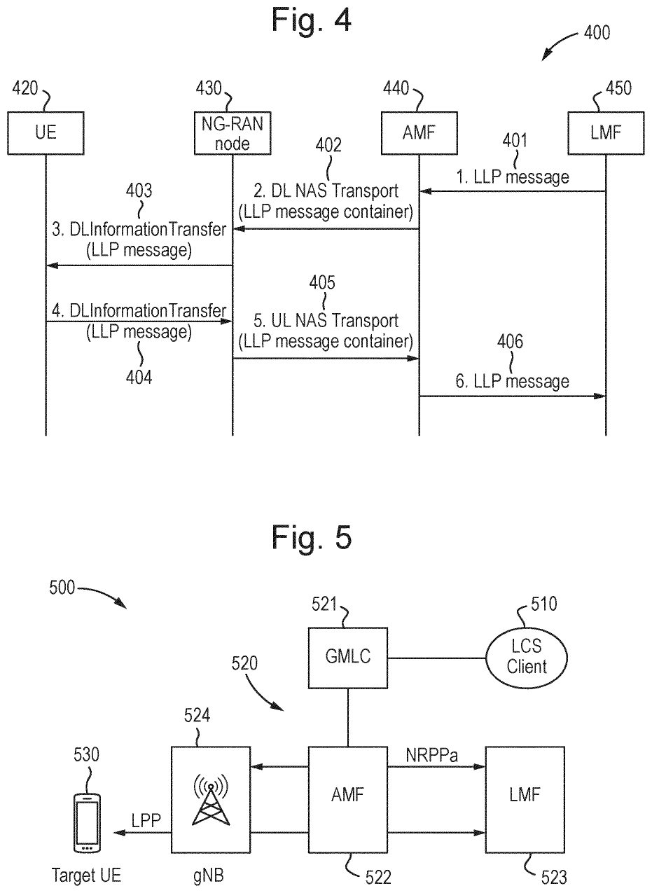

FIG. 4 illustrates an example 400 of LPP message transfer between an LMF 450 (location server) and a UE 420. LPP messages are carried as transparent protocol data units (PDUs) across intermediate network interfaces using the appropriate protocols.

In a first step 401, an LMF 450 sends an LPP message to an AMF 440. The LPP message may be the Request Capabilities message to request the UE 420 to send its positioning capabilities. This is illustrated as, “LPP message”.

In a further step 402, the AMF 440 transports the received LPP message to an NG-RAN 430 node by including the LPP message into the LPP message container of a DL NAS Transport message. This is illustrated as, “DL NAS Transport (LPP message container)”.

In a further step 403, the NG-RAN node 430 transports the received LPP message container to the UE 420 by including the LPP message container into an RRC DLInformationTransfer message as specified in 3GPP Technical Specification TS 38.331 titled, “NR Radio Resource Control (RRC) Protocol specification”. This is illustrated as, “DLInformationTransfer (LPP Message)”.

In a further step 404, upon receiving the Request Capabilities message, the UE 420 generates the Provide Capabilities message as the response. The UE 420 sends then the Provide Capabilities message to the NG-RAN node 430 by including the LPP message into an RRC ULInformationTransfer message as specified in 3GPP Technical Specification TS 38.331 titled, “NR Radio Resource Control (RRC) Protocol specification”. This is illustrated as, “ULInformationTransfer (LPP message)”.

In a further step 405, the NG-RAN node 430 transports the LPP message received from the UE 420 to the AMF 440 by including the LPP message into the LPP message container of the UL NAS Transport message. This is illustrated as, “UL NAS Transport (LPP message container)”.

In a further step 406, the AMF 440 extracts the LPP message from the received NAS message/LPP message container and sends it to the LMF 450. This is illustrated as, “LPP message”.

FIG. 5 illustrates an example of a Location Service (LCS) architecture 500. The LCS feature in 3GPP provides the mechanisms to support mobile location services for operators, subscribers and third-party service providers. Examples of location-based services include emergency services, tracking services, location-based information services (navigation, city sightseeing, location dependent content broadcast, mobile yellow pages etc.). The location information may be requested by and reported to a client (application) associated with the UE, or by a client within or attached to the 5GC. In FIG. 5, an external LCS client 510 requests the 5GC 520 for the current location of a target UE 530. The Figure shows the relation of the various LCS entities, as will now be described in greater detail.

The external LCS Client 510 interacts with GMLC 521 for the purpose of obtaining location information for one or more (target) UEs 530. The LCS Client 510 may reside in a UE and may be implemented as hardware (HW) or software (SW) (i.e. an application). Examples for LCS client 510 include 911 emergency dispatch centre (PSAP), and Google maps.

The GMLC 521 is the first node an external LCS client 510 accesses in a public land mobile network (PLMN) and works as a location server to an external application, for location information.

The LMF 523 manages the overall co-ordination and scheduling of resources required for the location of a UE 530 that is registered with or accessing 5GC 520. It also calculates or verifies a final location and any velocity estimate and may estimate the achieved accuracy. The LMF 523 processes the location services request which may include transferring assistance data to the target UE 530 to assist with UE-based and/or UE-assisted positioning and/or may include positioning of the target UE 530. The LMF 523 then returns the position estimate for the UE 530 back to an access and mobility management function (AMF) 522. In the case of a location service requested by an entity other than the AMF 522 (e.g., a GMLC 521 or UE), the AMF 522 returns the location result to this entity. In C-plane the LMF 523 works as location server.

The AMF 522 contains functionality responsible for managing positioning for a target UE 530 for all types of location request. The AMF 522 receives a request for some location services associated with a particular target UE 530 from another entity (e.g., GMLC 521 or UE) or the AMF 522 itself decides to initiate some location service on behalf of a particular target UE 530 (e.g., for an emergency call from the UE). The AMF 522 then sends a location services request to an LMF 523.

The NG-RAN node 524 (i.e. gNB) is involved in the handling of various positioning procedures including positioning of a target UE 530, provision of location related information not associated with a particular target UE 530 and transfer of positioning messages between an AMF 522 or LMF 523 and a target UE 530.

The target UE 530 is the UE whose position (absolute or relative) is to be obtained by the network or by the UE itself.

NRPPa is the C-plane radio network layer signalling protocol between an NG-RAN node 524 (gNB) and the LMF 523.

LPP is a point-to-point positioning protocol that supports positioning and location related services for a target device. In C-plane, LPP is terminated between a target device 530 and an LMF 523.

Certain types of location requests, specified in 3GPP, will now be briefly described.

A Network Induced Location Request (NI-LR), relates to a serving AMF for a UE initiating localization of the UE for a regulatory service (e.g. an emergency call from the UE) or for verification of a UE location (country or international area) for NR satellite access.

A Mobile Terminated Location Request (MT-LR), relates to an LCS client external to or internal to a serving PLMN sending a location request to the PLMN for the location of a target UE.

A Mobile Originated Location Request (MO-LR), relates to a UE sending a request to a serving PLMN for location related information for the UE itself.

An Immediate Location Request, relates to an LCS client sending or instigating a location request for a target UE (or group of target UEs) and expecting to receive a response containing location information for the target UE (or group of target UEs) within a short time period, which may be specified using LCS QoS. In regulatory cases, one or more responses of the target UE's location information can be expected. An immediate location request may be used for an NI-LR, MT-LR or MO-LR.

A Deferred Location Request, relates to an LCS client sending a location request to a PLMN for a target UE (or group of target UEs) and expecting to receive a response containing the indication of event occurrence and location information if requested for the target UE (or group of target UEs) at some future time (or times), which may be associated with specific events associated with the target UE (or group of target UEs). Deferred location requests are supported only for an MT-LR.

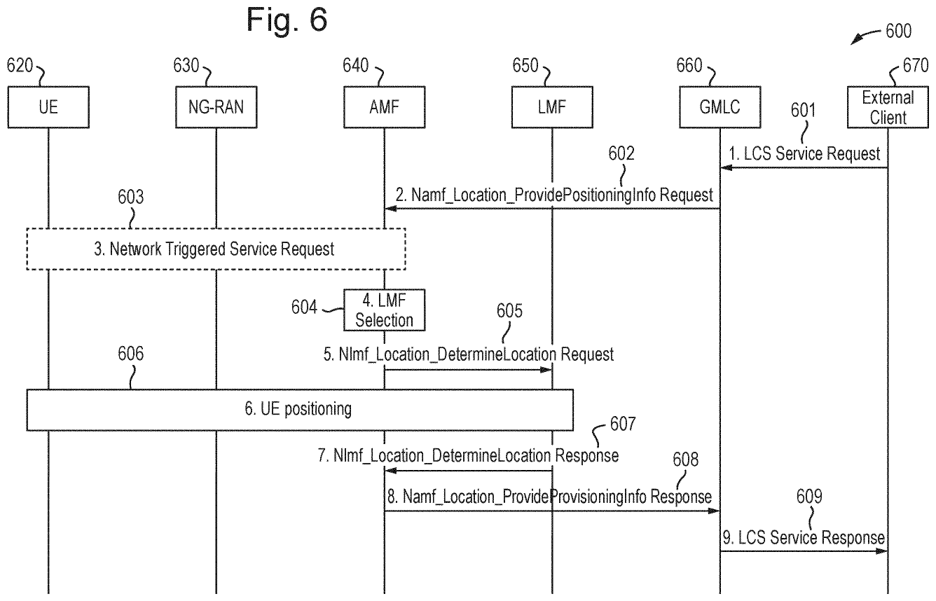

FIG. 6 illustrates an example 600 of the 5GC-MT-LR procedure for the regulatory location service for non-roaming scenario as specified in 3GPP Technical Specification TS 23.273, titled “5G System (5GS) Location Services (LCS)—Stage 2”. In this scenario, an external LCS client 670 requests the 5GC for the current location of a target UE 620. It is assumed that the target UE 620 is identified using a SUPI or GPSI.

In a first step 601, the external client 670 sends a request to the GMLC 660 for the current location of the target UE 620. The request includes amongst other items, the requested LCS QoS. This is illustrated as, “LCS Service Request”.

In a further step 602, the GMLC 660 sends a Namf_Location_ProvidePositioningInfo Request to an AMF 640 to request the current location of the UE 620.

In a further step 603, if the UE 620 is in CM-IDLE state, the AMF 640 initiates a network triggered Service Request procedure to establish a signalling connection with the UE 620. This is illustrated as, “Network Triggered Service Request”.

In a further step 604, the AMF 640 selects an LMF 650 based on the available information (e.g. requested LCS QoS, LMF capabilities, LMF load, LMF location) or based on AMF local configuration (if AMF 640 is configured locally with a mapping table of UE identity and LMF address). This is illustrated as, “LMF Selection”.

In a further step 605, the AMF 640 sends a Nlmf_Location_DetermineLocation Request to the selected LMF 650 to request the current location of the UE 620. The request includes amongst other items, the requested LCS QoS and the UE positioning capability if available.

In a further step 606: the LMF 650 performs positioning procedures and determines the geographical location of the UE 620. This is illustrated as, “UE positioning”.

In a further step 607, the LMF 650 returns a Nlmf_Location_DetermineLocation Response towards the AMF 640 to return the current location of the UE 620, i.e. the location estimate and accuracy, and may include information about the positioning method and the timestamp of the location estimate.

In a further step 608, the AMF 640 returns a Namf_Location_ProvidePositioningInfo Response towards the GMLC 660 to return the current location of the UE 620.

In a further step 609, the GMLC 660 sends the location service response including the location information of the UE 620, to the external client 670. This is illustrated as, “LCS Service Response”.

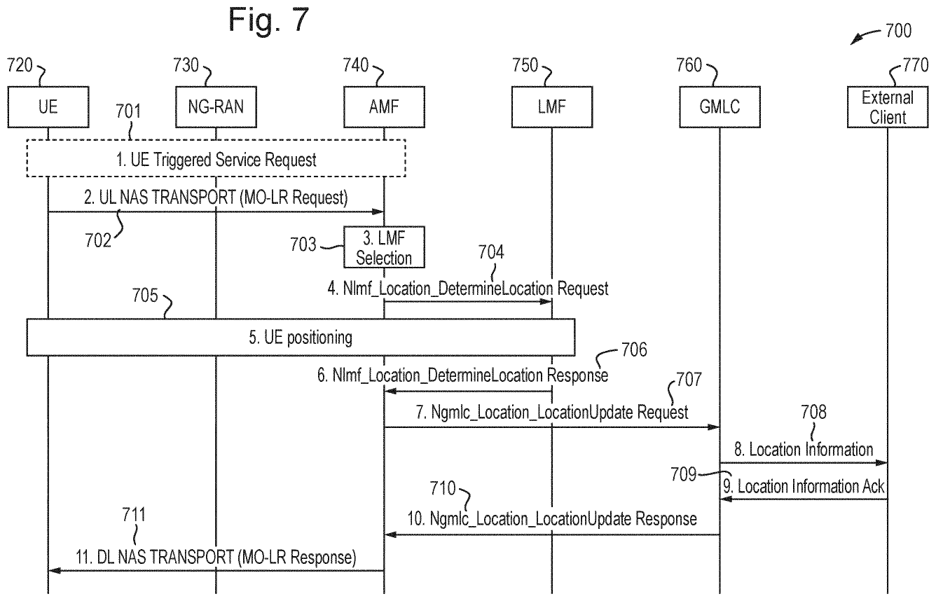

FIG. 7 shows an exemplary 5GC-MO-LR procedure 700 as specified in 3GPP Technical Specification TS 23.273, titled “5G System (5GS) Location Services (LCS)—Stage 2”, wherein a UE requests the serving PLMN to obtain the location of itself or just provide positioning assistance data. It is assumed that an LCS client resides in the UE and initiates the MO-LR.

In a first step 701, if the UE 720 is in CM-IDLE state, UE 720 instigates the UE triggered Service Request procedure in order to establish a signalling connection with an AMF 740. This is illustrated as, “UE Triggered Service Request”.

In a further step 702, the UE 720 sends an MO-LR Request message included in a UL NAS TRANSPORT message to the AMF 740. Different types of location services can be requested: location estimate of the UE, location estimate of the UE to be sent to an LCS client, or positioning assistance data. If the UE 720 is requesting its own location or that its own location be sent to an LCS client (e.g. for using a location-based service), this message carries the requested LCS QoS information (e.g. accuracy, response time). If the UE 720 is requesting that its location be sent to an LCS client, the message also includes the identity of the LCS client and the address of the GMLC through which the LCS client should be accessed. If the UE 720 is instead requesting positioning assistance data, the embedded LPP message specifies the type of assistance data and the positioning method for which the assistance data applies.

In a further step 703, the AMF 740 selects an LMF 750 based on the available information (e.g. requested LCS QoS, LMF capabilities, LMF load, LMF location) or based on AMF local configuration (if AMF 740 is configured locally with a mapping table of UE identity and LMF address). This is illustrated as, “LMF Selection”.

In a further step 704, the AMF 740 sends a Nlmf_Location_DetermineLocation Request to the selected LMF 750. The request includes amongst other items, an indication whether a location estimate, or positioning assistance data is requested.

In a further step 705, if the UE 720 is requesting its own location, the LMF 750 performs positioning procedures and determines the geographical location of the UE 720. If the UE 720 is instead requesting positioning assistance data, the LMF 750 transfers this data to the UE 720. This is illustrated as, “UE Positioning”.

In a further step 706, when a location estimate best satisfying the requested LCS QoS has been obtained or when the requested location assistance data has been transferred to the UE 720, the LMF 750 returns a Nlmf_Location_DetermineLocation Response towards the AMF 740. The response includes the location estimate, its age and accuracy. If the UE 720 is requesting positioning assistance data, steps 707 to 711 are skipped.

In a further step 707, if the location estimate was successfully obtained, the AMF 740 sends an Ngmlc_Location_LocationUpdate Request to a GMLC 760. The request carries the identity of the UE 720, the event causing the location estimate (5GC-MO-LR) and the location estimate, its age and obtained accuracy indication. In addition, the request includes the identity of an LCS Client 770.

In a further step 708, the GMLC 760 transfers the Location Information message to the LCS client 770, carrying the identity of the UE 720, the event causing the location estimate (5GC-MO LR) and the location estimate in accordance with the LCS QoS requested by the UE 720.

In a further step 709, the LCS Client 770 sends the GMLC 760 a Location Information Ack message signalling that the location estimate of the UE 720 has been received successfully.

In a further step 710, the GMLC 760 sends a Ngmlc_Location_LocationUpdate Response to AMF 740 to acknowledge the successful reception of the location estimate by the LCS Client 770.

In a further step 711, the AMF 740 sends an MO-LR Response message included in a DL NAS TRANSPORT message. If the UE 720 is requesting its own location, the response carries any location estimate requested by the UE 720 and the timestamp of the location estimate (if available) including the indication received from LMF 750 whether the obtained location estimate satisfies the requested accuracy or not, or an indicator whether a location estimate was successfully transferred to the identified LCS client 770.

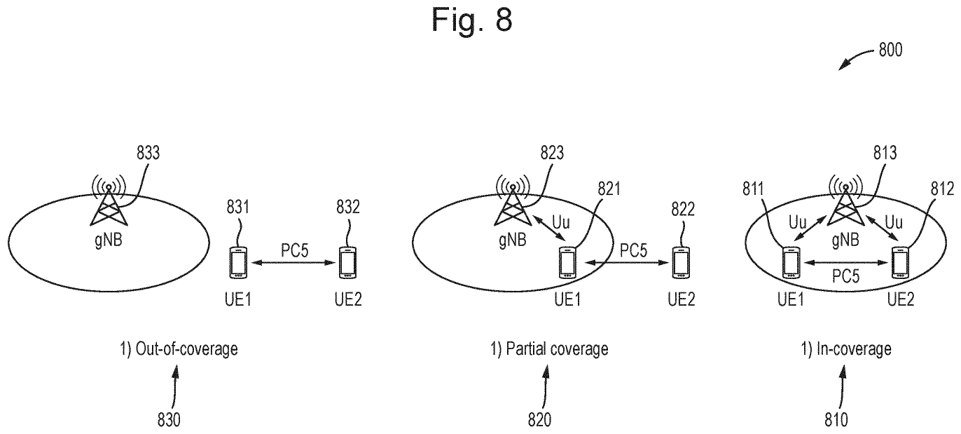

NR SL communication and discovery will now be further described. The feature of SL communication was introduced in 3GPP Rel-16 NR, to support V2X and non-V2X services. The interface used for SL communication (transmission/reception) between two UEs in proximity is denoted as PC5. Table 5 and FIG. 8 show the scenarios 800 which are supported for SL communication where a first UE (UE1) 811, 821, 831 and a second UE (UE2) 812, 822, 832 are located in-coverage (IC) 810, partial coverage (PC) 820 and out-of-coverage (OOC) 830 of a cell (gNB) 813, 823, 833.

TABLE 5

| # | Coverage scenario | UE1 | UE2 |
|---|---|---|---|
| 830 | Out-of-coverage | Out-of-coverage | Out-of-coverage |
| 820 | Partial coverage | In-coverage | Out-of-coverage |
| 810 | In-coverage | In-coverage | In-coverage |

The transmission and reception of user traffic over the PC5 interface is supported for unicast, groupcast and broadcast transmission. The transmission and reception of signaling traffic over the PC5 interface is supported only for unicast transmission. An SL connection over PC5 is defined as a logical connection between a pair of Source and Destination Layer-2 IDs. Source and Destination Layer-2 IDs identify the sender and the target of the SL communication, respectively. And for a cast type a corresponding pair of a Source Layer-2 ID and a Destination Layer-2 ID is used. The SL communication is based on the Proximity-based Services (ProSe) feature.

In order to enable SL communication between UEs in proximity the SL discovery procedure may need to be performed by the UEs. The SL discovery procedure is used by UE(s) to discover or to be discovered by other UE(s) in proximity. For instance, a UE that wants to discover other UE(s) in proximity transmits a discovery message over PC5. Other UE(s) in proximity monitor the discovery message and if they want to be discovered they respond with a discovery response message. After discovery the UE can establish an SL communication connection with each of the UE(s) which responded. More details of NR sidelink communication and discovery can be found in the 3GPP Technical Specification TS 23.304 titled, “Proximity based Services (ProSe) in the 5G System (5GS)”.

Certain SL positioning terminologies are relevant for the disclosure herein. These terminologies will now be briefly discussed, and are used to refer to roles of particular UE/devices participating in an SL positioning session.

An Initiator device initiates an SL positioning/ranging session. The Initiator device may be a network entity, (e.g., gNB, LMF) or UE/roadside unit (RSU).

A Responder device responds to an SL positioning/ranging session from an initiator device. The Responder device may be a network entity, (e.g., gNB, LMF) or UE/roadside unit (RSU).

A Target UE is a UE of interest whose position (absolute or relative) is to be obtained by the network or by the UE itself.

The term, ‘sidelink positioning’ refers to positioning of a UE using reference signals transmitted over SL, i.e., PC5 interface, to obtain absolute position, relative position, or ranging information.

The term ‘ranging’ refers to the determination of the distance and/or the direction between a UE and another entity, e.g., an Anchor UE.

An Anchor UE is a UE supporting positioning of Target UE, e.g., by transmitting and/or receiving reference signals for positioning, providing positioning-related information, etc., over the PC5 interface (also may be referred to as SL Reference UE).

An Assistant UE is a UE supporting Ranging/Sidelink between an SL Reference UE and a Target UE over PC5, when the direct Ranging/Sidelink positioning between the SL Reference UE/Anchor UE and the Target UE cannot be supported. The measurement/results of the Ranging/Sidelink Positioning between the Assistant UE and the SL Reference UE and that between the Assistant UE and the Target UE are determined and used to derive the Ranging/Sidelink Positioning results between Target UE and SL Reference UE.

An SL Positioning Server UE is a UE offering location calculation, for SL Positioning and Ranging based service. It interacts with other UEs over PC5 as necessary in order to calculate the location of the Target UE. The Target UE or SL Reference UE can act as SL Positioning server UE if location calculation is supported.

An SL Positioning Client UE is a third-party UE, other than the SL Reference UE and Target UE, which initiates Ranging/Sidelink positioning service request on behalf of the application residing on it.

In order to support SL positioning in joint PC5-Uu-based positioning operation scenarios, a number of solutions are herein proposed. These include an indication of a UE's SL positioning capabilities to a network; an extension of the Nlmf_Location_DetermineLocation Request message; and the definition of new LPP/SLPP messages for server-to-server communication.

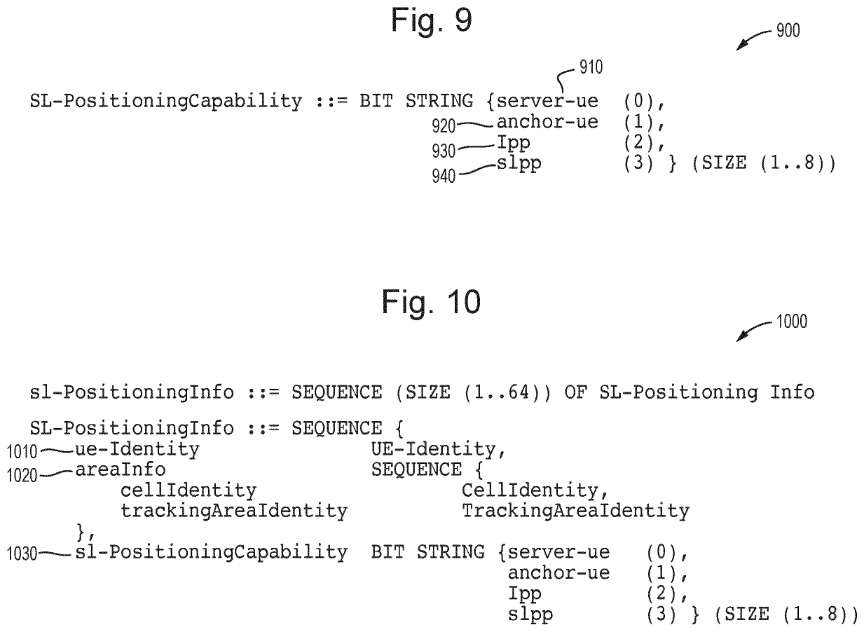

Regarding the indication of a UE's SL positioning capabilities to a network, a UE indicates to AMF its SL positioning capabilities as part of NAS signaling, e.g. in the NAS registration request message as specified in 3GPP Technical Specification TS 24.501 titled, “Non-Access-Stratum (NAS) protocol for 5G System (5GS)—Stage 3”. FIG. 9 illustrates an embodiment 900 of the format of SL positioning capability signaling. As illustrated, the format 900 is defined as a bitstring and the UE sets the concerned bit if the corresponding capability is supported. The value “server-ue” 910 is set if the UE can act as a Server UE, the value “anchor-ue” 920 is set if the UE can act as an Anchor UE, the value “lpp” 930 is set if the UE supports LPP and the value “slpp” 940 is set if the UE supports SLPP. Alternatively, the UE may indicate to a RAN node (i.e. gNB) its SL positioning capabilities as part of AS signaling, i.e. in the UE capability information message as specified in 3GPP Technical Specification TS 38.331 titled, “NR Radio Resource Control (RRC) Protocol specification”. The RAN node then forwards the information to AMF.

Regarding the extension of the Nlmf_Location_DetermineLocation Request message, the Nlmf_Location_DetermineLocation Request message (as specified in 3GPP Technical Specification TS 29.572 titled, “5G System Location Management Services—Stage 3”) is extended to include SL positioning information. The SL positioning information contains the list of available Anchor and Server UEs in the area of the Target UE. FIG. 10 illustrates an embodiment 1000 for the format of this list. The format 1000 of the list may contain up to 64 entries and each entry contains the information about the identity of the UE (value of “ue-Identity” 1010), the area in which the UE is located (value of “areaInfo” 1020 given by cell identity and tracking area identity) and the SL positioning capabilities supported by the UE (value of “sl-PositioningCapability” 1030).

Regarding the definition of the new LPP/SLPP messages, new LPP/SLPP messages “Determine Location Request” and “Determine Location Response” for server-to-server communication are defined.

The “Determine Location Request” message is sent from an LMF to a Server UE to request the location of a Target UE. This message includes the requested LCS QoS for the location estimation of the Target UE and information about available Anchor UEs in the area of the Target UE.

The “Determine Location Response” message is sent from the Server UE to the LMF and includes the location estimate and accuracy of the Target UE.

Alternatively, if the Server UE is LPP capable then existing LPP messages can be used as Request/Response messages, e.g. RequestLocationInformation and ProvideLocationInformation messages as specified in 3GPP Technical Specification TS 37.355, titled “LTE Positioning Protocol (LPP)”.

Advantages of the proposed solutions include SL positioning in joint PC5-Uu-based positioning operation scenarios being supported when an SL positioning capable LMF is available but due to current load the LMF may decide that an SL Positioning Server UE executes the result calculation, method determination, assistance data distribution and/or Anchor UE selection; and when an LMF is available that is not SL positioning capable.

FIG. 11 illustrates the message flow in an embodiment 1100 of a joint PC5-Uu based positioning operation scenario, which conveys the benefits of the proposed solutions. In this particular embodiment 1100, certain assumptions are made. These include that the Target UE, Anchor UE and Server UE are all in network coverage. Furthermore, the embodiment is applicable for MO-LR and MT-LR procedures. Based on the location request from an LCS Client (not shown in FIG. 11) SL positioning needs to be performed for the Target UE (determined by LCS QoS). Furthermore, the assumption is made that the LMF is capable of SL positioning.

FIG. 11 illustrates the message flow in an embodiment 1100 of a joint PC5-Uu-based positioning operation scenario.

In steps 1101a/1101b, 1102a/1102b, 1103a/1103b, during the successful NAS registration procedure the UEs (Target UE 1120, Anchor UE 1180 and Server UE 1190) indicate their SL positioning capabilities to AMF 1140. These steps are illustrated as, “Registration Request” and “Registration Accept” for each UE 1120, 1180 and 1190.

The Target UE 1120 indicates its support of LPP and SLPP, and the bits for “server-ue” 910 and “anchor-ue” 920 in FIG. 9 are not set.

The Anchor UE 1180 indicates its support of LPP and SLPP. Furthermore, it indicates that it can act as Anchor UE and the bit for “server-ue” 910 in FIG. 9 is not set.

The Server UE 1190 indicates its support of LPP and SLPP. Furthermore, it indicates that it can act as Server UE and the bit for “anchor-ue” 920 in FIG. 9 is not set.

In a further step 1104, the AMF 1140 selects the SL positioning capable LMF 1150 based on local configuration, i.e. based on the mapping of the Target UE identity and LMF address. This is illustrated as, “LMF Selection”.

In a further step 1105, the AMF 1140 sends an Nlmf_Location_DetermineLocation Request message to the selected LMF 1150. The request includes amongst other the request for a location estimate of the Target UE, the requested LCS QoS, and SL positioning information containing the available Anchor 1180 and Server 1190 UEs in the area of the Target UE 1120.

In a further step 1106, due to current load the selected LMF 1150 decides that SL Positioning Server UE 1190 executes the result calculation, method determination, assistance data distribution and Anchor UE selection. Therefore, it sends to the Server UE 1190 the “Determine Location Request” message over LPP or SLPP to request the location of the Target UE 1120. The “Determine Location Request” message includes the requested LCS QoS for the location estimation of the Target UE 1120 and information about available Anchor UEs in the area of the Target UE 1120.

In a further step 1107, SL positioning of the Target UE 1120 is performed between the Server UE 1190, Anchor UE 1180 and Target UE 1120.

In a further step 1108, the Server UE 1190 sends to the LMF 1150 a “Determine Location Response” message over LPP or SLPP. The response message includes the location estimate and accuracy of the Target UE 1120.

In a further step 1109, the LMF 1150 sends an Nlmf_Location_DetermineLocation Response message to the AMF 1140 to return the current location of the Target UE 1120, i.e. the location estimate and accuracy.

The disclosure herein provides a user equipment ‘UE’ apparatus for wireless communication, comprising: a processor; and a memory coupled with the processor, the processor configured to cause the UE apparatus to: transmit, to a first apparatus of a wireless communication network, a first message, wherein the first message comprises one or more parameters indicating sidelink positioning capabilities of the UE apparatus.

In some embodiments, the first apparatus comprises an access and mobility management function ‘AMF’.

In some embodiments, the processor is configured to cause the UE apparatus to transmit the first message as part of a non-access stratum ‘NAS’ registration request message.

In some embodiments, the one or more parameters are selected from the list of parameters consisting of: a server-UE parameter, indicating whether the UE apparatus can act as a server-UE for location calculation for sidelink positioning; an anchor-UE parameter, indicating whether the UE apparatus can act as an anchor-UE for supporting sidelink positioning, an LTE positioning protocol ‘LPP’ parameter, indicating whether the UE apparatus supports LPP; and a sidelink positioning protocol ‘SLPP’ parameter, indicating whether the UE apparatus supports SLPP.

In some embodiments, the UE provides the one or more parameters indicating sidelink positioning capabilities as part of AS signaling to a RAN node, the RAN node then forwarding these to an AMF.

In some embodiments, the processor is further arranged to cause the UE apparatus to: receive, from a second apparatus of the wireless communication network, a second message requesting sidelink positioning of a target UE, wherein the second message comprises: one or more quality of service ‘QoS’ requirements for location estimation of the target UE; and one or more identifiers of one or more anchor-UEs in a target area of the target UE.

The second message may be referred to as a “determine location request” LPP/SLPP message, or, the second message may be part of an existing LPP message.

In some embodiments, the processor is further configured to cause the UE apparatus to: determine an estimated location and associated location accuracy of the target UE, using the one or more QoS requirements and the one or more anchor-UEs.

In some embodiments, the processor is further configured to cause the UE apparatus to: transmit, to the second apparatus, a third message, wherein the third message comprises the estimated location and associated location accuracy.

In some embodiments, the second apparatus comprises a location management function ‘LMF’.

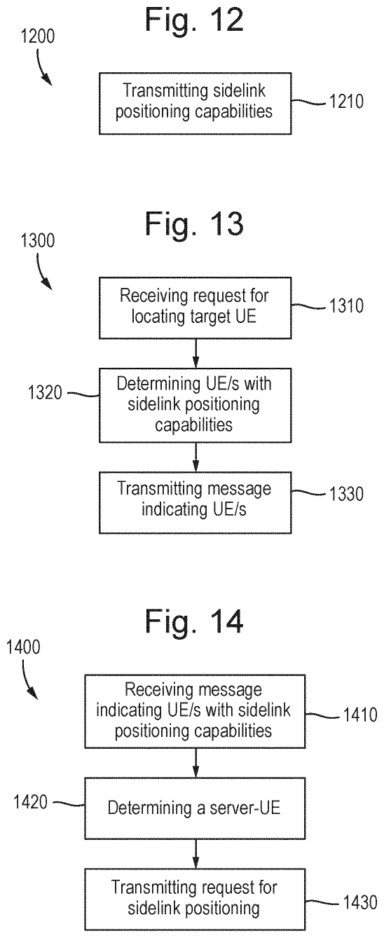

FIG. 12 illustrates an embodiment 1200 of a method in a user equipment apparatus for wireless communication.

A first step 1210 comprises transmitting, to a first apparatus of a wireless communication network, a first message, wherein the first message comprises one or more parameters indicating sidelink positioning capabilities of the UE apparatus.

In certain embodiments, the method 1200 may be performed by a processor executing program code, for example, a microcontroller, a microprocessor, a CPU, a GPU, an auxiliary processing unit, a FPGA, or the like.

In some embodiments, the first apparatus comprises an AMF.

In some embodiments, the one or more parameters are selected from the list of parameters consisting of: a server-UE parameter, indicating whether the UE apparatus can act as a server-UE for location calculation for sidelink positioning; an anchor-UE parameter, indicating whether the UE apparatus can act as an anchor-UE for supporting sidelink positioning, an LPP parameter, indicating whether the UE apparatus supports LPP; and an SLPP parameter, indicating whether the UE apparatus supports SLPP.

In some embodiments, the method further comprises receiving, from a second apparatus of the wireless communication network, a second message requesting sidelink positioning of a target UE, wherein the second message comprises: one or more QoS requirements for location estimation of the target UE; and one or more identifiers of one or more anchor-UEs in a target area of the target UE.

In some embodiments the method further comprises determining an estimated location and associated location accuracy of the target UE, using the one or more QoS requirements and the one or more anchor-UEs.

In some embodiments, the method further comprises transmitting, to the second apparatus, a third message, wherein the third message comprises the estimated location and associated location accuracy.

In some embodiments, the second apparatus comprises an LMF.

The disclosure herein further provides, a first apparatus in a wireless communication network, comprising: a processor; and a memory coupled with the processor, the processor configured to cause the first apparatus to: receive, from a consumer entity, a request for locating a target UE in a target area; determine, one or more UE apparatuses having respective sidelink positioning capabilities in the target area; and transmit, to a second apparatus of the wireless communication network, a fourth message indicating the one or more UE apparatuses and their respective sidelink positioning capabilities.

The consumer entity, in some embodiments, may comprise a UE, a network entity, and/or an external client.

In some embodiments, the processor is configured to cause the first apparatus to determine the one or more UE apparatuses, by causing the first apparatus to: receive, from the one or more UE apparatuses, one or more respective first messages, wherein each respective first message comprises one or more parameters indicating sidelink positioning capabilities of the respective UE apparatus.

In some embodiments, the processor is configured to cause the first apparatus to receive the one or more first messages as part of respective NAS registration request messages.

In some embodiments, the one or more parameters are selected from the list of parameters consisting of: a server-UE parameter, indicating whether the respective UE apparatus can act as a server-UE for location calculation for sidelink positioning, an anchor-UE parameter, indicating whether the respective UE apparatus can act as an anchor-UE for supporting sidelink positioning; an LPP parameter, indicating whether the respective UE apparatus supports LPP; and an SLPP parameter, indicating whether the respective UE apparatus supports SLPP.

In some embodiments, the fourth message comprises a list of anchor-UE apparatuses and server-UE apparatuses in the target area of the target UE.

In some embodiments, each entry in the list comprises: an identifier for the respective UE; a location area of the respective UE; and the SL positioning capabilities of the respective UE.

In some embodiments, the request for locating the target UE in the target area comprises one or more QoS requirements for location estimation of the target UE, and wherein the fourth message comprises the one or more QoS requirements.

The fourth message may comprise a Nlmf_Location_DetermineLocation Request message.

In some embodiments, the processor is further configured to cause the first apparatus to: determine the second apparatus, based on a predetermined mapping of the target UE to the second apparatus.

In some embodiments, the processor is further configured to cause the first apparatus to: receive, from the second apparatus, a fifth message, the fifth message comprising an estimated location and associated location accuracy, of the target UE.

In some embodiments, the processor is further configured to cause the first apparatus to transmit the estimated location and location accuracy to the consumer entity.

The fifth message may be a Nlmf_Location_DetermineLocation response message.

In some embodiments, the first apparatus comprises an AMF, and the second apparatus comprises an LMF.

FIG. 13 illustrates an embodiment 1300 of a method in a first apparatus in a wireless communication network.

A first step 1310 comprises receiving, from a consumer entity, a request for locating a target UE in a target area.

A further step 1320 comprises determining, one or more UE apparatuses having respective sidelink positioning capabilities in the target area.

A further step 1330 comprises transmitting, to a second apparatus of the wireless communication network, a fourth message indicating the one or more UE apparatuses and their respective sidelink positioning capabilities.

In certain embodiments, the method 1300 may be performed by a processor executing program code, for example, a microcontroller, a microprocessor, a CPU, a GPU, an auxiliary processing unit, a FPGA, or the like.

In some embodiments, the determining the one or more UE apparatuses, comprises: receiving, from the one or more UE apparatuses, one or more respective first messages, wherein each respective first message comprises one or more parameters indicating sidelink positioning capabilities of the respective UE apparatus.

In some embodiments, the one or more parameters are selected from the list of parameters consisting of: a server-UE parameter, indicating whether the respective UE apparatus can act as a server-UE for location calculation for sidelink positioning, an anchor-UE parameter, indicating whether the respective UE apparatus can act as an anchor-UE for supporting sidelink positioning; an LPP parameter, indicating whether the respective UE apparatus supports LPP; and an SLPP parameter, indicating whether the respective UE apparatus supports SLPP.

In some embodiments the fourth message comprises a list of anchor-UE apparatuses and server-UE apparatuses in the target area of the target UE.

In some embodiments, each entry in the list comprises: an identifier for the respective UE; a location area of the respective UE; and the SL positioning capabilities of the respective UE.

In some embodiments the request for locating the target UE in the target area comprises one or more QoS requirements for location estimation of the target UE, and wherein the fourth message comprises the one or more QoS requirements.

Some embodiments comprise determining the second apparatus, based on a predetermined mapping of the target UE to the second apparatus.

Some embodiments further comprise receiving, from the second apparatus, a fifth message, the fifth message comprising an estimated location and associated location accuracy, of the target UE.

In some embodiments, the first apparatus comprises an AMF, and the second apparatus comprises an LMF.

The disclosure herein further provides, a second apparatus in a wireless communication network, comprising: a processor; and a memory coupled with the processor, the processor configured to cause the second apparatus to: receive, from a first apparatus of the wireless communication network, a fourth message indicating one or more UE apparatuses and their respective sidelink positioning capabilities for locating a target UE in a target area; determine a server-UE apparatus, from the one or more UE apparatuses, for performing location calculation for sidelink positioning of the target UE; and transmit, to the server-UE apparatus, a second message requesting sidelink positioning of the target UE, wherein the second message comprises: one or more QoS requirements for location estimation of the target UE; and one or more identifiers of one or more anchor-UEs in the target area of the target UE.

In some embodiments, the processor is further configured to cause the second apparatus to: receive, from the server-UE apparatus, a third message, wherein the third message comprises an estimated location and associated location accuracy of the target UE.

In some embodiments, the sidelink positioning capabilities for each UE apparatus comprises one or more parameters selected from the list of parameters consisting of: a server-UE parameter, indicating whether the UE apparatus can act as a server-UE for location calculation for sidelink positioning; an anchor-UE parameter, indicating whether the UE apparatus can act as an anchor-UE for supporting sidelink positioning, an LPP parameter, indicating whether UE apparatus supports LPP; and an SLPP parameter, indicating whether the UE apparatus supports SLPP.

In some embodiments, the second apparatus is an LMF and first apparatus is an AMF.

In some embodiments, the second message is a “determine location request” LPP/SLPP message, or if UE supports LPP, the second message may form part of existing LPP messages (i.e. RequestLocationInformation messages).

In some embodiments, the third message is a “determine location response” message, or could be an existing ProvideLocationInformation LPP message, from a server UE, that includes the location estimate and accuracy of target UE.

In some embodiments, the fourth message comprises a list of anchor-UE apparatuses and server-UE apparatuses in the target area of the target UE.

In some embodiments, each entry in the list comprises: an identifier for the respective UE; a location area of the respective UE; and the SL positioning capabilities of the respective UE.

In some embodiments, the processor is further configured to cause the second apparatus to receive, from the server-UE apparatus, a fifth message, the fifth message comprising an estimated location and associated location accuracy, of the target UE.

FIG. 14 illustrates an embodiment 1400 of a method in a second apparatus in a wireless communication network.

A first step 1410 comprises receiving, from a first apparatus of the wireless communication network, a fourth message indicating one or more UE apparatuses and their respective sidelink positioning capabilities for locating a target UE in a target area.

A further step 1420 comprises determining a server-UE apparatus, from the one or more UE apparatuses, for performing location calculation for sidelink positioning of the target UE.

A further step 1430 comprises transmitting, to the server-UE apparatus, a second message requesting sidelink positioning of the target UE, wherein the second message comprises: one or more QoS requirements for location estimation of the target UE; and one or more identifiers of one or more anchor-UEs in the target area of the target UE.

Some embodiments comprise, receiving, from the server-UE apparatus, a third message, wherein the third message comprises an estimated location and associated location accuracy of the target UE.

In certain embodiments, the method 1400 may be performed by a processor executing program code, for example, a microcontroller, a microprocessor, a CPU, a GPU, an auxiliary processing unit, a FPGA, or the like.

In some embodiments, the sidelink positioning capabilities for each UE apparatus comprises one or more parameters selected from the list of parameters consisting of: a server-UE parameter, indicating whether the UE apparatus can act as a server-UE for location calculation for sidelink positioning; an anchor-UE parameter, indicating whether the UE apparatus can act as an anchor-UE for supporting sidelink positioning, an LPP parameter, indicating whether the UE apparatus supports LPP; and an SLPP parameter, indicating whether the UE apparatus supports SLPP.

In some embodiments, the second apparatus is an LMF and the first apparatus is an AMF.

In some embodiments, the second message is a “determine location request” LPP/SLPP message, or if the UE supports LPP, part of an existing LPP message (i.e. RequestLocationInformation).

In some embodiments, the third message is a “determine location response” message, or could be part of an existing ProvideLocationInformation LPP message, from the server UE, that includes the location estimate and accuracy of target UE.

In some embodiments, the fourth message comprises a list of anchor-UE apparatuses and server-UE apparatuses in the target area of the target UE.

In some embodiments, each entry in the list comprises: an identifier for the respective UE; a location area of the respective UE; and the SL positioning capabilities of the respective UE.

Some embodiments comprise receiving, from the server-UE apparatus, a fifth message, the fifth message comprising an estimated location and associated location accuracy, of the target UE.

In order to support SL positioning in joint PC5-Uu-based positioning operation scenarios, a certain novel aspects of the proposed solutions are provided.

A first novel aspect comprises a UE that indicates to an AMF its SL positioning capabilities as part of NAS signaling, e.g. in the NAS registration request message. The SL positioning capabilities include an indication as to whether the UE can act as a Server UE and/or an Anchor UE, and whether the UE supports LPP and/or SLPP. Alternatively, the UE indicates to a RAN node (i.e. gNB) its SL positioning capabilities as part of AS signaling, i.e. in the UE capability information message and the RAN node forwards said information to the AMF.

A further novel aspect comprises the Nlmf_Location_DetermineLocation Request message being extended to include SL positioning information. The SL positioning information contains the list of available Anchor and Server UEs in the area of a Target UE.

A further novel aspect comprises new LPP/SLPP messages, defined herein, and referred to as “Determine Location Request” and “Determine Location Response”, for server-to-server communication. The “Determine Location Request” message is sent from an LMF to a Server UE to request the location of a Target UE. This message includes the requested LCS QoS for the location estimation of the Target UE and information about available Anchor UEs in the area of the Target UE. The “Determine Location Response” message is sent from a Server UE to an LMF and includes the location estimate and accuracy of the Target UE. Alternatively, if the Server UE is LPP capable, then existing LPP messages can be used as the Request/Response messages, e.g. RequestLocationInformation and ProvideLocationInformation messages.

There is provided, a method for sidelink positioning of a target device in network coverage, the method comprising: receiving a first message from a first communication device by a second communication device containing sidelink positioning capabilities; determining by the second communication device to select a third communication device in accordance with the received first message; transmitting a second message from the second communication device to the third communication device containing a request for sidelink positioning; determining by the third communication device to trigger sidelink positioning to a fourth communication device; and transmitting a third message from the third communication to the fourth communication device containing the request for sidelink positioning.

In some embodiments, the first communication device is a sidelink device, the second communication device is an AMF, the third communication device is an LMF, and the fourth communication device is a sidelink positioning server device.

In some embodiments, the first message containing sidelink positioning capabilities includes the indication of the supported positioning protocols or supported roles in sidelink positioning or any combination thereof.

In some embodiments, the second message containing a request for sidelink positioning includes the information of available sidelink positioning anchor and server devices in the area of the target device.

In some embodiments, the third message containing a request for sidelink positioning includes the requested QoS for the location estimation of the target device and information of available sidelink positioning anchor devices in the area of the target device.

It should be noted that the above-mentioned methods and apparatus illustrate rather than limit the invention, and that those skilled in the art will be able to design many alternative arrangements without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

Further, while examples have been given in the context of particular communication standards, these examples are not intended to be the limit of the communication standards to which the disclosed method and apparatus may be applied. For example, while specific examples have been given in the context of 3GPP, the principles disclosed herein can also be applied to another wireless communication system, and indeed any communication system which uses routing rules.

The method may also be embodied in a set of instructions, stored on a computer readable medium, which when loaded into a computer processor, Digital Signal Processor (DSP) or similar, causes the processor to carry out the hereinbefore described methods.

The described methods and apparatus may be practiced in other specific forms. The described methods and apparatus are to be considered in all respects only as illustrative and not restrictive. The scope of the invention is, therefore, indicated by the appended claims rather than by the foregoing description. All changes which come within the meaning and range of equivalency of the claims are to be embraced within their scope.

The following abbreviations are relevant in the field addressed by this document: 3GPP, 3rd Generation Partnership Project; 5GS, 5G System; A-GNSS, Assisted GNSS; AMF, Access and Mobility Management Function; AoA, Angle of Arrival; AoD, Angle of Departure; AS, Access Stratum; CM, Connection Management; DL, Downlink; DL TDOA, Downlink Time Difference of Arrival; E-CID, Enhanced Cell ID; FR, Frequency Range; GMLC, Gateway Mobile Location Centre; GNSS, Global Navigation Satellite System; GPSI, Generic Public Subscription Identifier; HW, Hardware; IC, In-coverage; IIoT, Industrial IoT; IoT, Internet of Things; KPI, Key Performance Indicator; LCS, Location Services; LMF, Location Management Function; LPP, LTE Positioning Protocol; LTE, Long Term Evolution; MO-LR, Mobile-Originated Location request; MT-LR, Mobile-Terminated Location request; Multi-RTT, Multi Round Trip Time; NAS, Non Access Stratum; NG-RAN, Next Generation RAN; NI-LR, Network Induced Location Request; NR, New Radio; NRPPa, NR Positioning Protocol A; OOC, Out-of-coverage; PC, Partial coverage; PDU, Protocol Data Unit; PHY, Physical Layer; PLMN, Public Land Mobile Network; PPP, Precise Point Positioning; ProSe, Proximity-based services; PRS, Positioning Reference Signal; PSAP, Public Safety Answering Point; QoS, Quality of Service; RAN, Radio Access Network; RAT, Radio Access Technology; RRC, Radio Resource Control; RSU, Roadside Unit; RTK, Real-Time Kinematic; SL, Sidelink; SLPP, Sidelink Positioning Protocol; SUPI, Subscription Permanent Identifier; SW, Software; TDOA, Time Difference of Arrival; TTFF, Time To First Fix; UE, User Equipment; UL, Uplink; V2X, Vehicle-to-Everything, and WID, Work Item Description.

1. A user equipment (UE) for wireless communication, comprising:
at least one memory; and
at least one processor coupled with the at least one memory and configured to cause the UE to:
transmit, to a first apparatus of a wireless communication network, a first message, wherein the first message comprises one or more parameters indicating sidelink positioning capabilities of the UE.

2. The UE of claim 1, wherein the first apparatus comprises an access and mobility management function (AMF).

3. The UE of claim 1, wherein the one or more parameters include one or more of:
a server-UE parameter, indicating whether the UE is a server-UE for location calculation for sidelink positioning;
an anchor-UE parameter, indicating whether the UE is an anchor-UE for supporting sidelink positioning;
an LTE positioning protocol (LPP) parameter, indicating whether the UE supports LPP; or
a sidelink positioning protocol (SLPP) parameter, indicating whether the UE supports SLPP.

4. The UE of claim 3, wherein the at least one processor is further configured to cause the UE to:
receive, from a second apparatus of the wireless communication network, a second message requesting sidelink positioning of a target UE, wherein the second message comprises:
one or more quality of service (QoS) requirements for location estimation of the target UE; and
one or more identifiers of one or more anchor-UEs in a target area of the target UE.

5. The UE of claim 4, wherein the at least one processor is further configured to cause the UE to determine an estimated location and associated location accuracy of the target UE, using the one or more QoS requirements and the one or more anchor-UEs.

6. The UE of claim 5, wherein the at least one processor is further configured to cause the UE to transmit, to the second apparatus, a third message, wherein the third message comprises the estimated location and associated location accuracy.

7. The UE of claim 4, wherein the second apparatus comprises a location management function (LMF).

8. A first apparatus for wireless communication, comprising:
at least one memory; and
at least one processor coupled with the at least one memory and configured to cause the first apparatus to:
receive, from a consumer entity, a request for locating a target user equipment (UE) in a target area;
determine one or more UEs having respective sidelink positioning capabilities in the target area; and
transmit, to a second apparatus in a wireless communication network, a message indicating the one or more UEs and their respective sidelink positioning capabilities.

9. The first apparatus of claim 8, wherein the at least one processor is configured to cause the first apparatus to determine the one or more UEs by causing the first apparatus to receive, from the one or more UEs, one or more respective first messages, wherein each respective first message comprises one or more parameters indicating sidelink positioning capabilities of the respective UE.

10. The first apparatus of claim 9, wherein the one or more parameters include one or more of:
a server-UE parameter, indicating whether the respective UE is a server-UE for location calculation for sidelink positioning;
an anchor-UE parameter, indicating whether the respective UE is an anchor-UE for supporting sidelink positioning;
an LTE positioning protocol (LPP) parameter, indicating whether the respective UE supports LPP; or
a sidelink positioning protocol (SLPP) parameter, indicating whether the respective UE supports SLPP.

11. The first apparatus of claim 10, wherein the message comprises a list of anchor-UEs and server-UEs in the target area of the target UE.

12. The first apparatus of claim 11, wherein each entry in the list comprises:
an identifier for the respective UE;
a location area of the respective UE; and
the sidelink positioning capabilities of the respective UE.

13. The first apparatus of claim 8, wherein the request for locating the target UE in the target area comprises one or more quality of service (QoS)requirements for location estimation of the target UE, and wherein the message comprises the one or more QoS requirements.

14. The first apparatus of claim 8, wherein the at least one processor is further configured to cause the first apparatus to determine the second apparatus based on a predetermined mapping of the target UE to the second apparatus.

15. The first apparatus of claim 8, wherein the at least one processor is further configured to cause the first apparatus to receive, from the second apparatus, a second message comprising an estimated location and associated location accuracy of the target UE.

16. The first apparatus of claim 8, wherein the first apparatus comprises an access and mobility management function (AMF), and the second apparatus comprises a location management function (LMF).

17. A second apparatus for wireless communication, comprising:
at least one memory; and
at least one processor coupled with the at least one memory and configured to cause the second apparatus to:
receive, from a first apparatus in a wireless communication network, a first message indicating one or more user equipment (UEs) and their respective sidelink positioning capabilities for locating a target UE in a target area;
determine a server-UE from the one or more UEs for performing location calculation for sidelink positioning of the target UE; and
transmit, to the server-UE, a second message requesting sidelink positioning of the target UE, wherein the second message comprises:
one or more quality of service (QoS)requirements for location estimation of the target UE; and
one or more identifiers of one or more anchor-UEs in the target area of the target UE.

18. (canceled)

19. The second apparatus of claim 17, wherein the sidelink positioning capabilities for each UE comprises one or more parameters including one or more of:
a server-UE parameter, indicating whether the UE is a server-UE for location calculation for sidelink positioning;
an anchor-UE parameter, indicating whether the UE is an anchor-UE for supporting sidelink positioning;
an LTE positioning protocol (LPP) parameter, indicating whether the UE supports LPP; or
a sidelink positioning protocol (SLPP) parameter, indicating whether the UE supports SLPP.

20. The second apparatus of claim 17, wherein the second apparatus is a location management function (LMF) and the first apparatus is an access and mobility management function (AMF).

21. A method performed by a user equipment (UE), the method comprising:
transmitting, to a first apparatus of a wireless communication network, a first message that comprises one or more parameters indicating sidelink positioning capabilities of the UE.
